(19) United States
(12) Patent Application Publication
(10) Pub. No.: US 2024/0311467 A1
(43) Pub. Date: Sep. 19, 2024

(54) PASSWORD DONGLE FOR GENERATION AND RETRIEVAL OF SECURE PASSWORDS

(71) Applicant: Microchip Technology Incorporated, Chandler, AZ (US)

(72) Inventor: Keith Edwin Curtis, Queen Creek, AZ (US)

(73) Assignee: Microchip Technology Incorporated, Chandler, AZ (US)

(21) Appl. No.: 18/602,151

(22) Filed: Mar. 12, 2024

Related U.S. Application Data
(60) Provisional application No. 63/452,310, filed on Mar. 15, 2023.

(51) Int. Cl. G06F 21/46; G06F 21/34

(52) U.S. Cl. CPC G06F 21/46; G06F 21/34

(57) ABSTRACT

Systems and methods for generating login passwords for a personal computer applications, comprising: providing a personal computer utility; providing a universal serial bus dongle to generate pseudo-random strings of characters via a pseudo-random character generator to be used as passwords, retrieving a first index value by identifying a uniform resource locator of an internet resource requesting a password from a non-volatile index table of the personal computer utility; sending the first index value and a first request for a password from the personal computer utility to the universal serial bus dongle; retrieving a first seed value from a non-volatile seed table using the first index value received from the personal computer utility; and generating a first pseudo-random number password via a pseudo-random character generator using the first seed value.

### PRIORITY STATEMENT

The present application claims priority to U.S. Provisional Patent Application No. 63/452,310 filed Mar. 15, 2023, the contents of which are hereby incorporated in their entirety.

### TECHNICAL FIELD

The present disclosure relates to password credentials for signing-in to personal applications, and in particular, to a password dongle that generates passwords, retrieves passwords and encrypts communications to prevent “sniffing,” wherein generated passwords are random, secure, and out of reach of hackers.

### BACKGROUND

PC base applications generate passwords and store them encrypted on the hard drive. Computer users typically access many different applications, wherein each application has username and password login credentials to gain access to the application. Some applications may even use two-factor authentication to gain access to the application. To increase security, passwords are typically non-obvious and include a combination of characters, special characters, numbers, and letters. Users may also be prompted to change or update passwords periodically to enhance security. Employers who maintain sensitive information typically have policies for employees to keep password credentials secure, including not maintaining a hard copy of them, for example, written on a piece of paper or listed in rolodex cards.

Some application users employ low security practices and maintain login credentials, including user names and passwords on an electronic document (.doc or .pdf) from which users may simply cut and paste user names and passwords into sign-in pages of applications. However, maintaining login credentials in an electronic file make them easily accessible to hackers. If the login credentials are maintained in hard copy, the users may opt for physical security by locking the hard copy of the login credentials in a cabinet or other secure physical structure.

Login credentials are the most desirable information to be stolen by attackers, because an attacker can use login credentials to achieve legitimate user access—freedom to move about a corporate network undetected. Thereafter, any activity the attacker performs is cloaked under the guise of legitimate user behavior. This is made worse by traffic encryption, which shields the attacker from inspection by most network security tools.

There is a need to prevent login credentials from being stolen via password sniffing attacks. A password sniffing attack is a form of denial-of-service attack, which is carried out by sniffing or capturing packets on the network, and then either sending them repeatedly to a victim machine or replaying them back to the sender with modifications. Data packets may be captured as they are transmitted across a network. The attacker then uses a password-cracking program to obtain the actual passwords from the intercepted data. Using a sniffer tool, a hacker can capture sensitive information such as passwords and credit card numbers. Password sniffing can be used to obtain passwords for any type of account, including email, social media, and financial accounts. It is one of the most common types of attacks on both home and business networks.

Login credentials to gain remote access to a network through a virtual private network (VPN) are particularly vulnerable to security breaches.

Password vault applications have been employed to generate random passwords on demand. A password vault application may operate on a personal computer to allow a user to simply cut and paste user names and passwords into sign-in pages of applications from the password vault application. A password vault application may encrypt a list of usernames and passwords, and use a single username and password to gain access to the encrypted list. However, physical security is limited to the computer itself, remote access to the computer is allowed, and there is an option to decompile and recover passwords.

There is a need for a pseudo-random password generator that retrieves generated passwords, and secures the password communication process for credentialled login to personal computer applications.

### SUMMARY OF THE INVENTION

An example provides a system comprising: a personal computer utility comprising a personal computer controller and a non-transitory computer readable storage medium storing a non-volatile index table and instructions; and a universal serial bus dongle to generate and retrieve passwords, the universal serial bus dongle comprising: a universal serial bus interface, and non-transitory computer readable storage medium storing a non-volatile seed table and instructions that, when executed by the controller, cause the universal serial bus dongle to generate pseudo-random strings of characters via a pseudo-random character generator to be used as passwords, wherein the instructions of the personal computer utility, when executed by the personal computer controller, cause the personal computer utility to retrieve a first index value by identifying a uniform resource locator of an internet resource requesting a password in the non-volatile index table of the personal computer utility and send the first index value and a first request for a password to the universal serial bus dongle; wherein the instructions of the universal serial bus dongle, when executed by the controller, cause the universal serial bus dongle to: retrieve a first seed value from its non-volatile seed table using the first index value received from the personal computer utility, and generate a first pseudo-random number password via the pseudo-random character generator using the first seed value.

According to an example, there is provided a method comprising: providing a personal computer utility; providing a universal serial bus dongle to generate pseudo-random strings of characters via a pseudo-random character generator to be used as passwords, retrieving a first index value by identifying a uniform resource locator of an internet resource requesting a password from a non-volatile index table of the personal computer utility; sending the first index value and a first request for a password from the personal computer utility to the universal serial bus dongle; retrieving a first seed value from a non-volatile seed table using the first index value received from the personal computer utility; and generating a first pseudo-random number password via a pseudo-random character generator using the first seed value.

### BRIEF DESCRIPTION OF THE DRAWINGS

The figures illustrate examples of a password dongle that generates passwords, retrieves passwords and encrypts communications via pseudo-random password generators that retrieve generated passwords, and secure the password communication process for credentialled login to personal computer applications.

FIG. 1 shows a perspective view of a password dongle.

FIG. 2 shows a perspective view of a password dongle having a USB plug and a personal computer having a USB port.

FIG. 3 shows a block diagram of a password dongle system of the password dongle of FIG. 1 and a block diagram of a personal computer system of the personal computer of FIG. 2.

FIG. 4 shows a flow chart for installing the first time the PC application is run and the first time the dongle is plugged into the personal computer.

FIG. 5 shows a flow chart for booting the personal computer circuit at start up and booting the dongle when it is plugged in to the personal computer.

FIGS. 6A-6B show a flow chart for creating a new password.

FIGS. 7A-7B show a flow chart for retrieving an existing password.

FIG. 8 shows a flow chart for generating a login password for a personal computer application.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an example, there is provided a password dongle that keeps a rolling code sequenced prior to actions. New passwords may be generated from a rolling code (starting value +password). All communications from the password dongle to a PC application may be encrypted/decrypted with a current rolling code. A starting seed code value may be a combination of an dongle identity number and a user input number.

Examples include a password dongle that uses a rolling code to generate passwords and saves generated passwords by their starting code and index number. The password dongle may communicate passwords using encryption based on the current rolling code. Passwords may not be stored on the PC into which the password dongle is plugged. Passwords and communications may be encrypted using rolling codes. Actual passwords are regenerated when requested, but not stored. The password dongle may generate and recover passwords using a rolling code.

The password dongle may be physically secured independent of a PC. The password dongle may be removed from a personal computer or network docking station and physically locked up in a cabinet for further security.

The password dongle may be unlocked by a touch interface on the password dongle that generates an unlock code upon touching. An unlock code may be used to gain access to or unlock the password dongle to provide additional security. The password dongle may be touched by user, wherein the password dongle may employ a touch interface, such as a button or biometric (finger print) reader on the password dongle, to unlock it. A user may enter or input an unlock code via buttons on the password dongle.

Examples provide a password dongle for generating pseudo-random passwords, retrieving generated passwords, and securing the password process for credentialled sign-in to personal computer applications (PC Apps). The password dongle may communicate a password encrypted with a latest rolling code value. The encryption may change with every communication. The password dongle may be physically secured separately from the encryption scheme. The password dongle may regenerate passwords based on starting seed value so there is no list of passwords stored in the password dongle. Information stored in the password dongle may be protected by a code protection scheme. The password dongle may be flash based without a boot loader. All passwords may be pseudo-random based on separate rolling code sequences. Access of passwords may be coordinated with the user touching a touch interface on the password dongle, such as a button or a biometric fingerprint reader.

A pseudo-random number generator (RNG) is a math equation that takes a seed value and generates a new pseudo-random number. When the RNG starts, it is fed a seed value, and it generates a new random number. The new random number is then fed to the RNG and a second random number is generated. Then that random number is fed to the RNG and a third random number is generated. This sequence is repeated endlessly generating a random sequence of numbers. A purpose of the RNG may be to generate a sequence of numbers that are reasonably random in both values and bit patterns. The RNG may generate a new random number on the order of 50-100 times a second.

A rolling code generator (RCG) is similar to a RNG and is a math equation that takes the seed code and generates a new random code, which is then fed back to generate another random code, and so on. A difference with a RCG is that two RCGs may synchronized. So both RCGs start with the same seed code and each generates their first rolling code, which is the same identical code. Then this identical code is feed back into each of the RCGs and they generate a second identical rolling code and so on. The two RCGs may generate synchronized new rolling codes at the same time so the new (random) rolling codes for both RCGs are the same, but random when compared to the previous rolling codes.

A password dongle and a computer or PC App may use synchronized RCGs. The password dongle and a computer or PC App may utilize RNGs or RCGs, such as a KEELOQ® system to generate pseudo-random passwords, retrieve generated passwords, and secure the password communication process for credentialled sign-in to personal computer applications (PC Apps).

KEELOQ® is a registered trademark of Microchip Technology Incorporated. KEELOQ@ may be used to encrypt/decrypt data for transmission via the password dongle to PC applications. The KEELOQ® system and other applications thereof are more fully described in commonly owned U.S. Pat. Nos. 6,985,472; 6, 191,701; 6, 175,312; 6, 166,650; 6,108,326; 5.841,866: 5,686,904; and 5,517,187, all of which are hereby incorporated in their entireties by reference herein for all purposes.

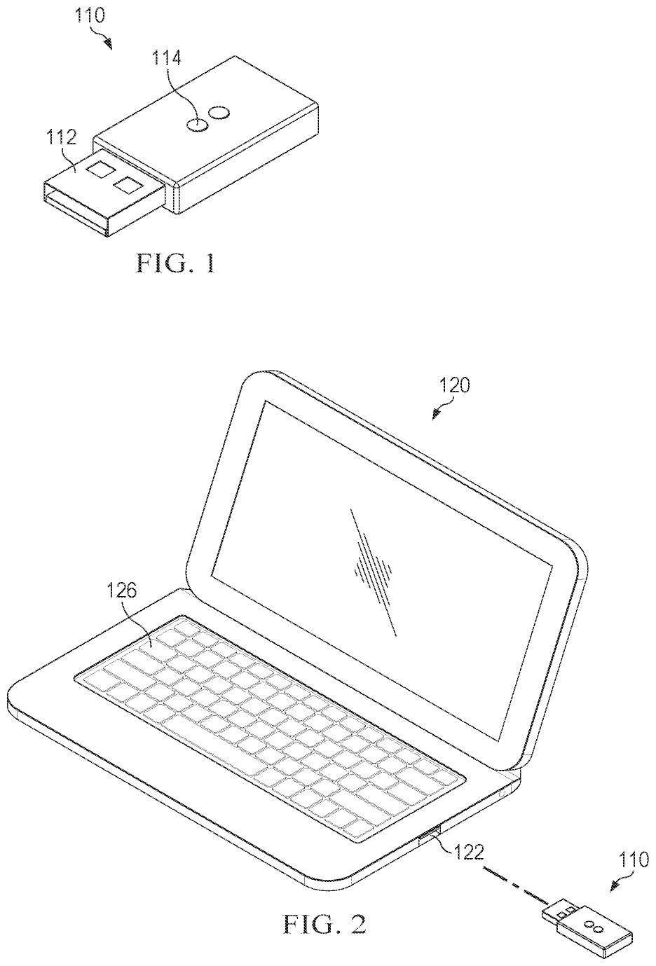

FIG. 1 illustrates a perspective view of a password dongle 110. The password dongle 110 has a USB plug 112 for engagement with a USB port of a personal computer. The password dongle 110 has a touch interface 114, such as buttons 114, which may be used to unlock the password dongle 110 for use, and may also be used to input a user input number. The touch interface 114 may be a fingerprint reader, a biometric sensor, a single push bottom, or a set of buttons.

FIG. 2 illustrates a perspective view of the password dongle 110 of FIG. 1 and a personal computer 120. The personal computer 120 has a USB port 122 and a keyboard 126.

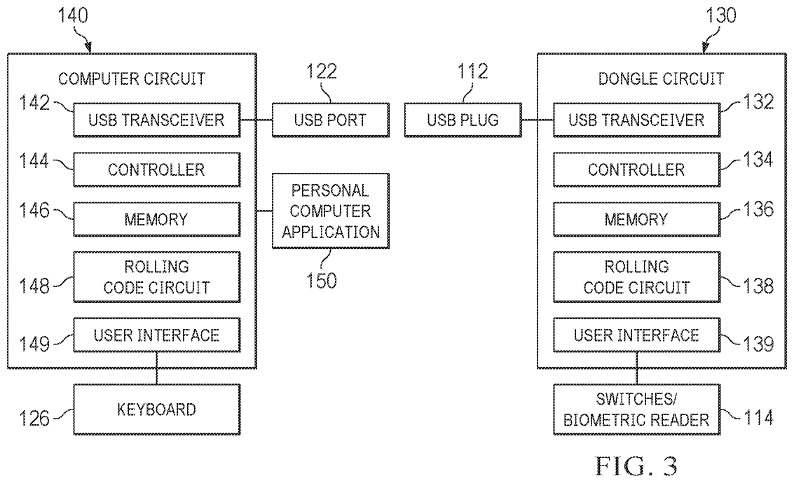

FIG. 3 shows a block diagram of a dongle circuit 130 of the password dongle 110 of FIG. 1 and a block diagram of a computer circuit 140 of the personal computer 120 of FIG. 2. The dongle circuit 130 comprises a USB transceiver 132, a controller 134, a memory 136, a rolling code circuit 138, and a user interface 139. The USB transceiver 132 transmits and receives messages through the USB Plug 112. The user interface 139 receives information input from a user via the buttons or biometric reader 114. The computer circuit 140 comprises a USB transceiver 142, a controller 144, a memory 146, a rolling code circuit 148, and a user interface 149. The USB transceiver 142 transmits and receives messages through the USB Port 122. The user interface 149 receives information input from a user via the keyboard 126.

A personal computer application 150 to which the user is seeking to gain login access may be paired with the password dongle 110. To pair, the dongle circuit 130 may share a seed code value with the computer circuit 140.

According to one example, the password dongle 110 has an dongle circuit 130 capable of: (1) performing a non-linear encoding function on a seed code value and a combination of a unit number and a stepping counter value, so as to generate a password which is decodable by a decoding circuit having access to the same seed code value; and (2) generating, upon a synchronization command being given thereto, a counter value which is encodable together with the synchronization command, to generate a synchronization message value which will facilitate the synchronization of a decoder circuit having the same seed code value. The encoder circuit may further change, e.g. increment or decrement the counter value by a number greater than one, after a given period of time subsequent to the encoder circuit being operated.

The encoding function may be described by the following equation:

^{f}encode (seed code value, (unit number, counter value))=message value.

The dongle circuit and computer circuit may use non-linear functions. This type of function is often used in the field of cryptography and is usually chosen for its characteristics which prevent or at least inhibit the prediction of its next output even though the non-linear function as well as previous outputs thereof may be known, as long as the seed code value remains unknown.

The unit number may be at least a one bit value. Although it may extend into thousands of bits and even more, the longer the unit number the greater the security it offers.

The counter value may also be more than a one bit length and may also extend into thousands of bits and even more, where more bits increase the security.

A 16 bit unit number and a 16 bit counter value, when combined, give adequate security because they could each individually be combined in more than 65,000 different combinations and together they could be combined in more than 4000 million combinations. Similarly, the seed code value may be more than a one bit length and may be as long as 64 bits in which case more than 1019 different combinations are possible.

The message value may be at least 16 bits long. If its length is less than 16 bits, it will be less secure and consequently it will be easier to decode.

According to another example, there is provided a computer circuit capable of: (1) performing a decoding function on a received password and an seed code value, so as to generate from the synchronization message value, a decoded unit number and a decoded counter value; (2) comparing the decoded counter value with a decoder counter value range; and (3) upon a valid synchronization command having been decoded by the computer circuit, synchronizing the decoder counter value with the counter value of an encoder circuit which has generated the synchronization command.

According to a further example, there is provided a computer circuit capable of: (1) performing a decoding function on a received password and a seed code value, so as to generate from the synchronization message value, a decoded unit number and a decoded counter value; (2) comparing the decoded counter value with a decoder counter value range; (3) recognizing, in the decoded unit number, a synchronization command; and (4) storing the decoded counter value in the event of a valid message value having been received. The computer circuit may be capable of changing, e.g. incrementing or decrementing, the stored decoded counter value by a number greater than one after a period of time subsequent to the receipt of a valid synchronization message value. The computer circuit may be capable of performing a format scan on signals so as to identify and respond to valid synchronization message values.

The decoding function performed by the computer circuit may ensure that the decoded unit number and the decoded counter value are the same as, respectively. the unit number and the counter value encoded by an encoder circuit of a password dongle, which provides a seed code value to the computer circuit.

The computer circuit may also be capable of distinguishing between a decoded unit number for normal operation and a synchronization command.

The decoder counter value may conveniently not be accepted by the computer circuit as a valid counter value unless it is greater than the previously received valid counter value but less than the previously received valid counter value plus a value n, the value n constituting the number of lost codes the encoder circuit would still accept. Alternatively. in the event that the decoded unit number comprises a valid synchronization command, the computer circuit may be adapted to store the decoded counter value plus one as the decoder counter value for subsequent use.

The computer circuit may be capable of comparing the counter value with a value obtained from a uni-directional synchronization process to which the computer circuit may be subjected.

One example provides a combined dongle and computer circuit capable of: (1) performing a non-linear encoding function on a seed code value and a combination of a unit number and a stepping counter value, so as to generate a password that is decodable by a related decoding function having access to the same seed code value; (2) generating, upon a synchronization command being given thereto, a counter value which is encodable together with the synchronization command, to generate a synchronization message value which will facilitate the synchronization of a related computer circuit having the same seed code value; (3) performing a decoding function on a received synchronization message value and a seed code value, so as to generate from the synchronized message value, a decoded unit number and a decoded counter value; (4) comparing the decoded counter value with the decoded counter value range; and (5) upon a valid synchronization command having been decoded by the computer circuit, synchronizing the decoder counter value with the counter value of an encoder circuit that has generated the synchronization command.

According to a further example, there is provided a password dongle adapted to transmit a password receivable by a PC application 150 capable of responding thereto, the password dongle encoder means comprising means for performing an encoding function on a seed code value and a combination of a unit number and a variable counter value so as to generate a message value incorporated in the transmission, the message value being decodable through a related decoding function performed by the receiver remote control device.

The encoder circuit may be adapted to generate a stepping counter value through a uni-directional synchronization process for the synchronization of the PC application 150.

The computer circuit 140 may be capable of performing a decoding function on a combination of a synchronization message value and a seed code value, so as to generate a password for a PC application 150.

The memory of the dongle circuit may be retained by batteries or alternatively, by an alternate power source.

The dongle circuit may generate, when activated, a multibit password by performing a function on a seed code value, e.g. a dongle identity number, such as a serial number embedded in the password dongle, and a user input number such as a personal identification number (PIN), and a combination of a unit number and a counter value. The counter value may be incremented when the password dongle is activated.

The password dongle may have a USB transceiver 132 capable of generating a message comprising the password. The USB transceiver 132 may also be capable of transmitting a synchronization process, a synchronization multibit code word, wherein the synchronization multibit code word is a function of a seed code value, and a combination of a synchronization command word and a new counter value. The dongle circuit may further comprise panic means adapted to generate a panic command. Additionally, the dongle circuit may comprise electrically erasable programmable memory or read and write memory with standby mode in the dongle circuit to store the last counter value.

To facilitate the programming of a multibit user input number such as a personal identification number (PIN) into the memory. the password dongle may comprise a programmer that receives inputs from buttons 114.

As an additional safety feature, the dongle circuit may be capable of verifying the personal identification number (PIN) without being able to read it, and locking an interface with the personal identification number (PIN), in order to bar all further attempts to change or verify the personal identification number (PIN). The PC application 150 may have a decoder circuit capable of decoding the personal identification number (PIN) received from the password dongle. The decoder circuit may be capable of applying a function on the personal identification number (PIN) received from the receiver in such a manner as to yield the unit number and the counter value to which the encoding function has been applied.

The personal identification number (PIN) of the dongle circuit may be communicated from the password dongle to the decoder circuit of the PC application. otherwise the unit number and the counter value window of the decoder circuit would most probably not compare with the unit number and counter value to which the dongle circuit has applied the function and the received password would then be ignored.

The decoder circuit may be capable of: (1) comparing the decoded unit number of the transmitted password with its previously received seed code value, and upon agreement, (2) checking that the counter value falls inside a valid range of counter numbers, and if both conditions are satisfied. (3) giving an indication thereof to the outside, in the form of a flag, and (4) storing the received counter value if it was found to be valid.

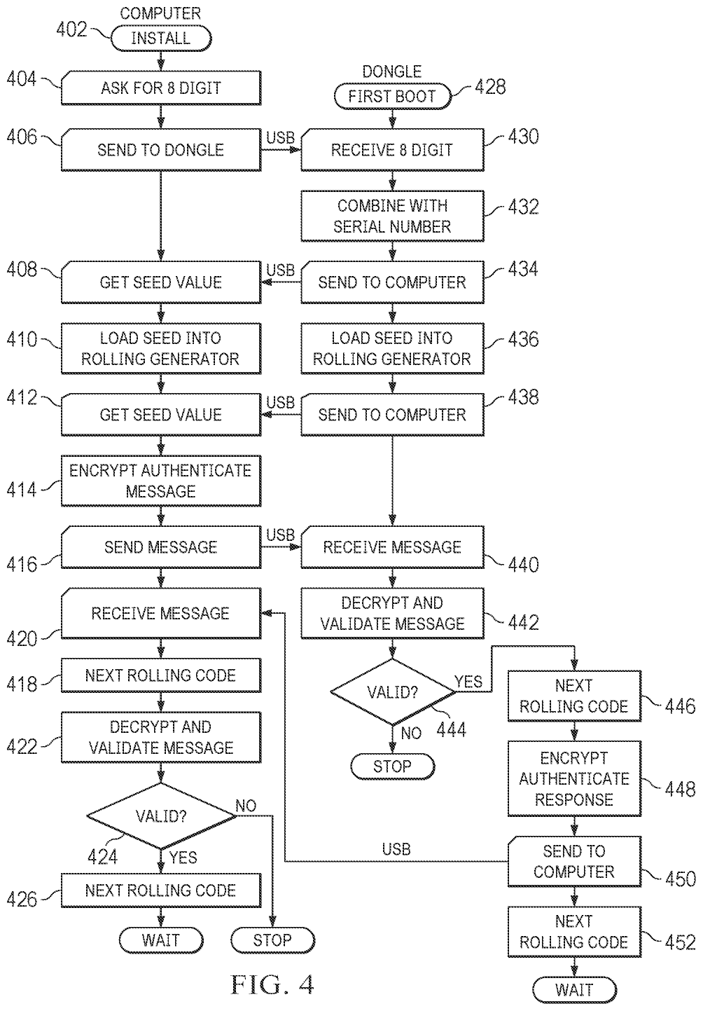

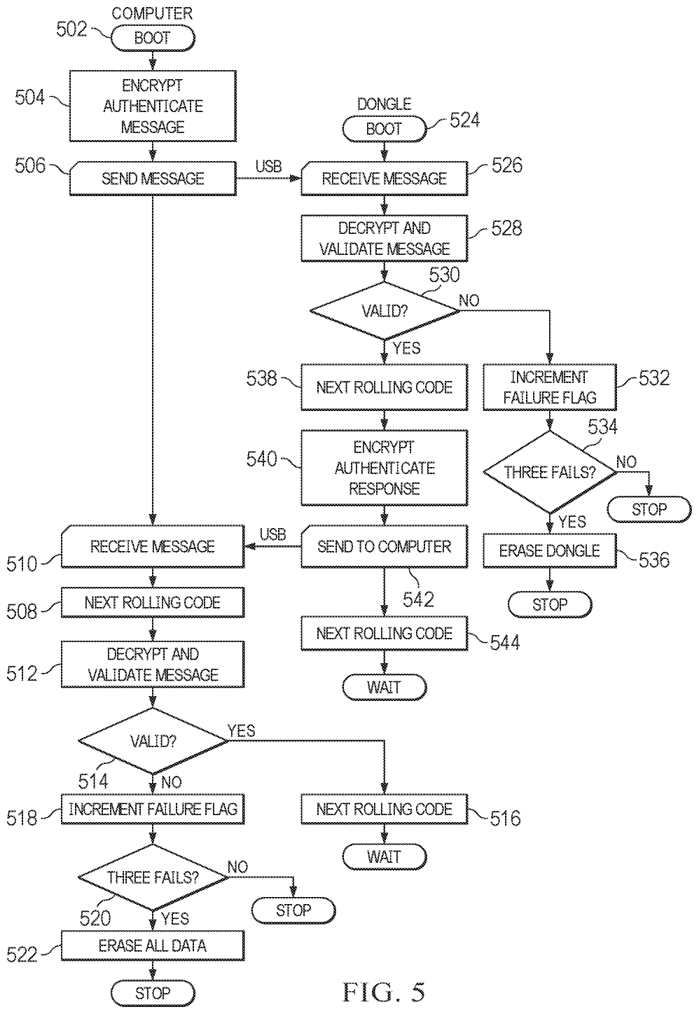

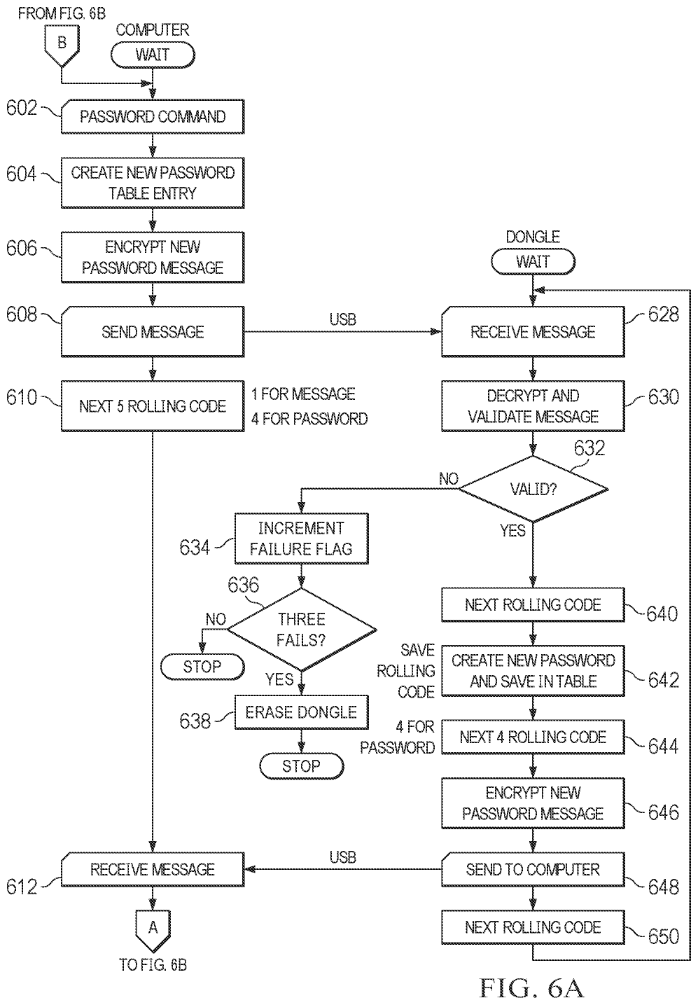

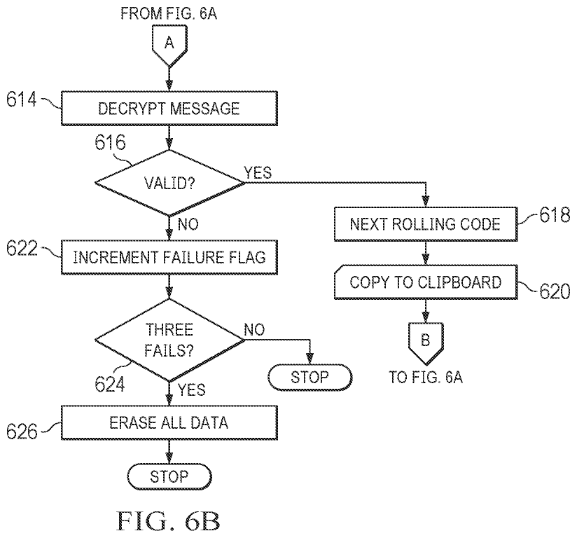

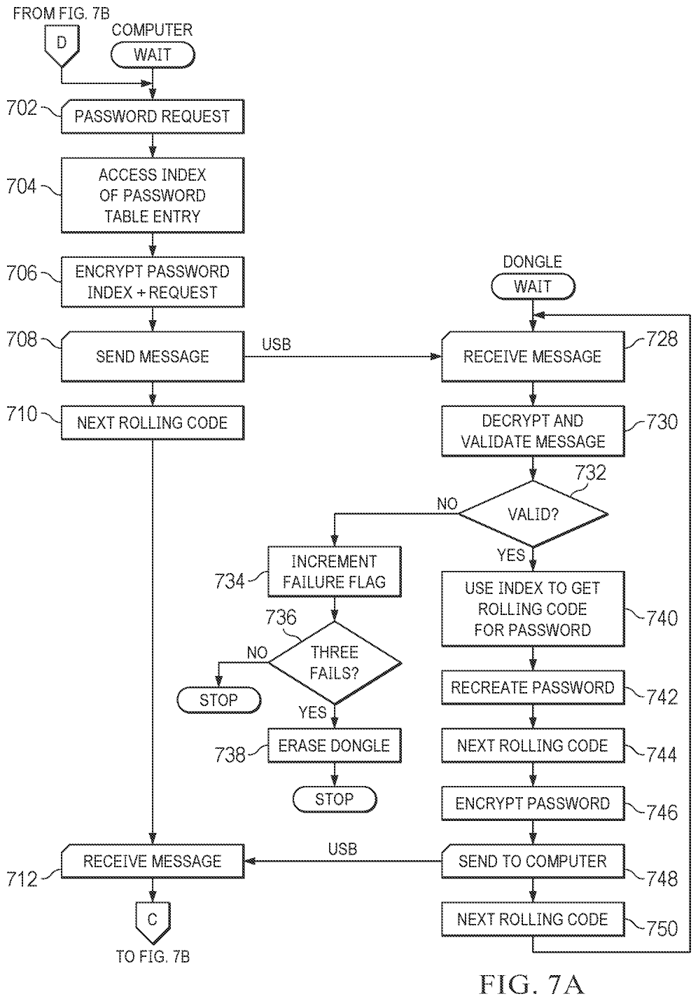

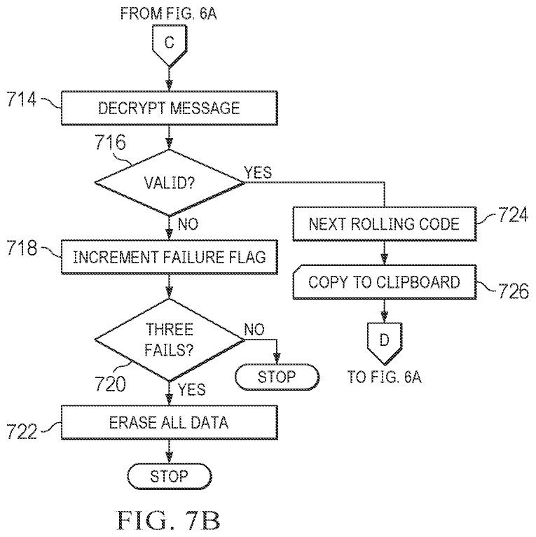

FIGS. 4-7 show flow charts for install, boot, password request, and new password, respectively. The two columns are for the PC application (left) and the dongle (right). Any place listed at stop if an infinite loop (waiting for a reset). The “Wait” is a loop waiting for a keyboard(mouse) input. Install is the first time the PC application is run and the first time the dongle is plugged into the PC. See FIG. 4. Boot is when the PC starts up and the dongle is plugged in to the PC. See FIG. 5. NewPassword is the creation of the new password. See FIGS. 6A-6B. PasswordRequest is the retrieval of an existing password. See FIGS. 7A-7B.

FIG. 4 shows a flow chart installing when the PC application is run for the first time and the dongle is plugged into the PC for the first time (INSTALL). On the computer, the PC application is installed 402. The PC application prepares a request to ask for 8 digit 404. The PC application sends 406 the 8 digit number to the dongle. The dongle boots 428 for the first time. The dongle receives 430 the 8 digit number from the PC application via USB connection. The dongle combines 432 the received 8 digit number with the dongle serial number to make a seed number. The dongle sends 434 the seed number to the computer and the computer receives 408 the seed number via USB connection. Both the computer and the dongle load 410 and 436 the seed number into a rolling code generator to generate a second seed number. The dongle sends 438 the second seed number to the computer and the computer gets 412 the second seed number. The computer uses the second seed number to encrypt and authenticate 414 a request message. The computer sends 416 and the dongle receives 440 the request message. The dongle decides 444 whether the request message is valid. If NO, the dongle stops. If YES, the dongle generates 446 a next rolling code, encrypts and authenticates 448 a response message, and sends 450 the response message to the computer while the computer receives 420 the response message via the USB connection. The dongle generates 452 the next rolling code and waits. The computer generates 418 a next rolling code. The computer decrypts and validates 422 the response message and decides 424 whether the response message is valid. If NO, the computer stops. If yes, the computer generates 426 the next rolling code and waits.

When the password dongle is first plugged into the PC, the password dongle and the PC application trade partial rolling codes-typically half of the bits of their current rolling code. It starts with the password dongle sending its partial code, and the PC application on the PC sends a partial of the next rolling code. A partial code may be sent to prevent sniffing of the current code by a hacker. Both the password dongle and the PC application check what they receive against what their RCG has generated and if they match then the password dongle and the PC application consider themselves synchronized and authenticated with one another. The password dongle then generates the next rolling code so its value matches the PC application. In the event that the partial rolling code values does not match the partial rolling code on the password dongle, the password dongle locks up until it is removed from the system. It also tracks the number of match failures and when it reaches a preselected number of sequential failures (for example, three), it may erase its password table.

A PC App to which the user is seeking to gain login access may be provided a password from the password dongle. Before the computer circuit may obtain a password for the PC App, the computer 140 circuit may be paired with the dongle circuit 130. Pairing is the process that occurs at the install, as described with reference to FIG. 4. The password dongle and the PC application may agree on a seed code value for the random sequence. This seed code value may consist of a dongle identity number and a user input number, which may be a random number entered by the user such as a personal identification number (PIN). At pairing, the rolling codes are synchronized and communications roll both the PC application and the dongle rolling codes at the same time. For the two RCGs in the system, the seed code value may be a combination of a random value supplied to the PC application and the dongle identity number (such as a serial number) programmed into the password dongle at manufacture. Because both RCGs start with the same seed code value, they may generate a matching sequence of rolling codes. Once both the PC application and the password dongle have the same seed code value, the password dongle is considered paired to the PC application.

The codes may be 128 to 256 bits. The current rolling code may be stored in non-volatile memory in the password dongle so it does not forget the code when the password dongle is removed from the USB port of a computer. All communications after pairing may be encrypted. Communications after pairing may include commands requesting a new password and index numbers for requesting an existing password.

FIG. 5 shows a flow chart for a boot process when the PC starts up and the dongle is plugged in the PC (BOOT). The computer boots 502 and the dongle boots 524. The computer encrypts and authenticates 504 a request message. The computer sends 506 the request message and the dongle receives 526 the request message via USB connection. The dongle decrypts and validates 528 the request message. The dongle then decides 530 whether the request message is valid. If NO, the dongle increments 532 a failure flag. The dongle then decides 534 whether the request message has failed to decrypt and validate three times. If NO, the dongle stops. If YES, the dongle erases 536 itself. If the dongle decides 530 the request message is valid (YES), then the dongle generates 538 the next rolling code. The dongle encrypts and authenticates the next rolling code to generate 540 a response message. The dongle sends 542 the response message and the computer receives 510 the response message via USB connection. The dongle generates 544 the next rolling code and waits. The computer generates 508 the next rolling code. The computer decrypts and validates 512 the response message. The computer decides 514 whether the response message is valid. If NO, the computer increments 518 a failure flag and decides 520 whether there have been three failures to decrypt and validate response messages. If NO, the computer stops. If YES, the computer erases 522 all data and stops. If the computer decides 514 the response message is valid (YES), then the computer generates 516 the next rolling code and then waits.

To generate a password, the PC application may first add the URL of the webpage to its password table with a unique sequence number. It may then generate a request for new password command, encrypt it with its current rolling code, and send the command to the password dongle. Upon receiving the command, the password dongle may decrypt the command using the current rolling code. The password dongle may then determine the next three rolling codes and use them to generate a password. The rolling code and the sequence number from the password request may be stored in the password table on the password dongle. The new password may then be encrypted with the next rolling code and sent back to the PC application. The PC application knows that generating a password uses three rolling codes so it may decrypt the message from the password dongle using the fourth rolling code past its current rolling code. At the end of the password creation, the PC application has another entry in its table with a unique sequence number and a URL. The password dongle has another entry in its table with the same sequence number and the rolling code used to generate the password.

FIGS. 6A-6B show a flow chart for creating a new password by the dongle for the PC application (NewPassword). After the computer and dongle are operating in wait modes, the computer generates 602 a command for a new password. The computer creates 604 a new password table entry. The computer encrypts 606 of a new password request message. The computer sends 608 the new password request message and the dongle receives 628 the new password request message via the USB connection. The computer generates 610 the next five rolling codes, one for a message and four for passwords. The dongle decrypts and validates 630 the new password request message. The dongle decides 632 whether the new password request message is valid. If NO, the dongle increments 634 a failure flag and decides 636 whether the new password request message has failed to validate three times. If NO, the dongle stops. If YES, the dongle erases 638 itself and stops. If the dongle decides 632 the new password request message is valid (YES), then the dongle generates 640 the next rolling code. The dongle saves this next rolling code and uses it to create 642 a new password, which it then saves in a password table. The dongle then generates 644 the next four rolling codes, which may be used for the next four passwords. The dongle encrypts 646 a new password response message. The dongle sends 648 and the computer receives 612 the new password response message via USB connection. The computer decrypts 614 the new password response message and decides 616 whether the new password response message is valid. If NO, the computer increments 622 a failure flag and decides 624 whether there have been three failures to decrypt and validate response messages. If NO, the computer stops. If YES, the computer erases 626 all data and stops. If the computer decides 616 the response message is valid (YES), then the computer generates 618 the next rolling code, copies 620 the next rolling code to a clipboard, and then waits.

To retrieve a password, the PC application may check the current browser URL against its list of URLs for which it has passwords. If it finds a match, it may retrieve the sequence number for the URL from its password table, encrypt the sequence number using the current rolling code, and send the sequence number plus a password retrieval command to the password dongle. The password dongle may decrypt the sequence number and the command using its current rolling code. It may then retrieve the rolling code corresponding to the sequence number from its password table and recreate the password using the RCG. The password may then be encrypted using the next rolling code and sent back to the PC application. The PC may then determine the next rolling code and decrypt the password using the next rolling code. The password may then be passed to the browser for transmission to the web page.

The PC application may identify a requested password index number. The password dongle may retrieve the starting seed code value using the index number. The password may be regenerated from the starting seed code value. The password may be encrypted using the current rolling code. The password may be sent to the PC application. The PC application decrypts the password.

FIGS. 7A-7B show a flowchart for retrieval of an existing password (PasswordRequest). From a waiting mode, the computer generates 702 a password request message. The computer accesses 704 its index of password table entries. The computer encrypts 706 the password index +password request message. The computer sends 708 and the dongle receives 728 the password index +password request message via the USB connection. The computer generates 710 the next rolling code. The dongle decrypts and validates 730 the password index +password request message. The dongle decides 732 whether the password index +password request message is valid. If NO, the dongle increments 734 a failure flag and decides 736 whether the password index +password request message has failed to validate three times. If NO, the dongle stops. If YES, the dongle erases 738 itself and stops. If the dongle decides 732 the password index +password request message is valid (YES), then the dongle uses 740 the index to get a rolling code for a password. The dongle recreates 742 the password. The dongle generates 744 the next rolling code. The dongle encrypts 746 the recreated password message. The dongle sends 748 and the computer receives 712 the recreated password message via USB connection. The dongle generates 750 the next rolling code and waits. The computer decrypts 714 the recreated password message and determines 716 whether the recreated password message is valid. If NO, the dongle increments 718 a failure flag and decides 720 whether the recreated password message has failed to validate three times. If NO, the computer stops. If YES, the computer erases 722 all data and stops. If the computer decides 716 the recreated password message is valid (YES), then the computer generates 724 the next rolling code. The computer copies 726 the next rolling code to a clipboard and waits.

The PC system may be either browser or PC application based. Both browser based and PC application based systems use the same functionality on the PC side. A difference may be that the PC application may be built into the browser on the browser-based system.

The system may also be a web page based PC application. In a web-based system, the PC application may reside on both the PC and the webpage server. The server may have an RCG and its own list of sequence numbers on its system. The PC application may decrypt data from the password dongle and then encrypt the message to the webpage servers with the next rolling code. During plugin, the password dongle and the PC application 150 authenticate, and then the PC application 150 and the webpage server authenticate in a similar manner. To make a web based PC application more useful, the password dongle and the PC application 150 may have multiple rolling codes on board, one for each web server. When a user redirects to a new URL, the password dongle may authenticate to the PC application's RCG and the PC application RCG may then authenticate to the server's RCG just as it does with a PC/Browser based PC application. In addition, the password may be passed to the PC, decrypted, encrypted with the next RCG, and sent to the web server for decryption by the PC application on the web server. Commands requesting passwords may be generated by the PC application 150 at the user's request.

The password dongle may keep a rolling code, sequenced prior to actions. The rolling code may be a RNG (KEELOQ®) wherein when a value is requested the previous value is input into an equation that generates the next random number. New passwords may be generated from a rolling code (starting value->password). All communications to a PC application may be encrypted/decrypted with a current rolling code. A starting seed code value may be a combination of a dongle identity number and a user input number. A dongle identity number of the password dongle may be programmed therein at the time of manufacture. A user input number may be input into the password dongle when the password dongle is plugged into the PC by passing a rolling code to the PC, which then generates the next rolling code and returns it. This is the validation that the password dongle and the PC application are synchronized and can work together. A user input number may be input into the password dongle may also be input via buttons on the password dongle.

The password dongle may use a URL and index number held for each sign-in page for various applications. A password request may be based on a starting seed code value, which may be a combination of a dongle identity number and a user input number. The password dongle may be authenticated by a seed code value when a PC application boots.

To start up a new password dongle, a user may insert the password dongle into the USB port of the personal computer. A dongle identity number may be entered into a PC application via a personal computer. The PC application may generate a starting seed code value using a dongle identity number and a user input number. The seed code value may be encrypted using a dongle identity number. The encrypted value may be sent to the password dongle.

A sequence may generate a new password. The PC application may generate a new USL and Index number in a list. The password dongle may log the index number and the next KEELOQ® value. The password dongle may generate a new password and encrypt it using the latest KEELOQ® value. The password dongle may send the encrypted password to the PC application.

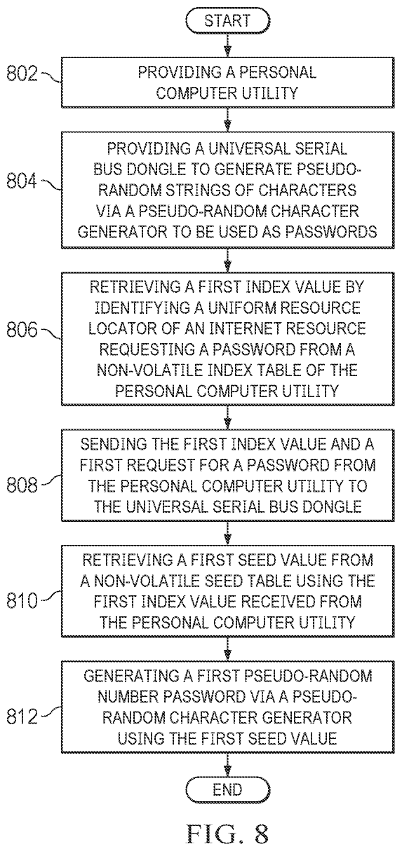

FIG. 8 shows a flow chart for generating a login password for a personal computer application. A personal computer utility is provided 802. A universal serial bus dongle is provided 804 to generate pseudo-random strings of characters via a pseudo-random character generator to be used as passwords. A first index value is retrieved 806 by identifying a uniform resource locator of an internet resource requesting a password from a non-volatile index table of the personal computer utility. The first index value and a first request for a password are sent 808 from the personal computer utility to the universal serial bus dongle. A first seed value is retrieved 810 from a non-volatile seed table using the first index value received from the personal computer utility. A first pseudo-random number password is generated 812 via a pseudo-random character generator using the first seed value.

Although examples have been described above, other variations and examples may be made from this disclosure without departing from the spirit and scope of these disclosed examples.

1. A system comprising:
a personal computer utility comprising a personal computer controller and a non-transitory computer readable storage medium storing a non-volatile index table and instructions; and
a universal serial bus dongle to generate and retrieve passwords, the universal serial bus dongle comprising:
a universal serial bus interface, and
non-transitory computer readable storage medium storing a non-volatile seed table and instructions that, when executed by the controller, cause the universal serial bus dongle to generate pseudo-random strings of characters via a pseudo-random character generator to be used as passwords,
wherein the instructions of the personal computer utility, when executed by the personal computer controller, cause the personal computer utility to retrieve a first index value by identifying a uniform resource locator of an internet resource requesting a password in the non-volatile index table of the personal computer utility and send the first index value and a first request for a password to the universal serial bus dongle;
wherein the instructions of the universal serial bus dongle, when executed by the controller, cause the universal serial bus dongle to: retrieve a first seed value from its non-volatile seed table using the first index value received from the personal computer utility, and generate a first pseudo-random number password via the pseudo-random character generator using the first seed value.

2. The system as in claim 1, wherein the pseudo-random character generator is to: generate a second pseudo-random number password in a sequence using the first pseudo-random number password as a second seed value, and generate a third pseudo-random number password in a sequence using the second pseudo-random number password as a third seed value.

3. The system as in claim 2, wherein the first, second, and third pseudo-random number passwords are 32-bit pseudo-random numbers, respectively, wherein the first, second, and third pseudo-random numbers are respectively broken into 6-bit values and added to an offset value to generate a sequence of ASCII characters selected from: numbers, punctuation, upper case letters, and lower case letters.

4. The system as in claim 1, comprising a switch on the universal serial bus dongle, wherein the instructions of the universal serial bus dongle, when executed by the controller, cause the universal serial bus dongle to: send the first pseudo-random number password to the personal computer utility for transmission to the uniform resource locator of the web resource requesting a password, if the switch on the universal serial bus dongle is activated.

5. The system as in claim 1, wherein the instructions of the personal computer utility, when executed by the personal computer controller, cause the personal computer utility to store the uniform resource locator of the internet resource requesting the password in the non-volatile index table of the personal computer utility.

6. The system as in claim 1, wherein the instructions of the personal computer utility, when executed by the personal computer controller, cause the personal computer utility to send a second index value and a second request for a password to the universal serial bus dongle.

7. The system as in claim 1, wherein the instructions of the universal serial bus dongle, when executed by the controller, cause the universal serial bus dongle to: store the first seed value in the non-volatile seed table using the first index value received from the personal computer utility.

8. The system as in claim 1, wherein the instructions of the universal serial bus dongle, when executed by the controller, cause the universal serial bus dongle to: generate a second pseudo-random number password via the pseudo-random character generator using the second seed value.

9. The system as in claim 1, wherein the instructions of the universal serial bus dongle, when executed by the controller, cause the universal serial bus dongle to: transmit the first pseudo-random number password to the personal computer utility, wherein the personal computer utility is to decode the first pseudo-random number password and transmit the first pseudo-random number password to the uniform resource locator of the internet resource requesting a password.

10. The system as in claim 1, comprising a single connection utility between the universal serial bus interface and the personal computer browser, wherein the instructions of the personal computer utility are incorporated in a server hosting an internet resource requesting a password.

11. The system as in claim 1, comprising a single connection utility between the universal serial bus interface and the personal computer browser, wherein the instructions of the personal computer utility are incorporated in the operating instructions of personal computer browser.

12. The system as in claim 1, wherein the personal computer utility comprises a pseudo-random number generator identical to the pseudo-random number generator of the universal serial bus dongle, wherein the pseudo-random number generators are synchronized, wherein the pseudo-random number generators both start generating numbers with an identical initial seed value, and wherein the instructions of the personal computer utility and the universal serial bus dongle, when executed by the respective controllers, cause the personal computer utility and the universal serial bus dongle to: encrypt and decrypt communications between the universal serial bus dongle and the personal computer utility using a single key cypher based on a rolling key generated by the synchronized pseudo-random number generators in the personal computer utility and the universal serial bus dongle.

13. The system as in claim 12, wherein the identical initial seed value for the synchronized pseudo-random number generators is created by concatenation of a serial number of the universal serial bus dongle and a value supplied by a user.

14. The system as in claim 12, wherein the instructions of the personal computer utility and the universal serial bus dongle, when executed by the respective controllers, cause the personal computer utility and the universal serial bus dongle to: increment an error count when communication fails to decrypt, wherein an error count of greater than a predetermined value results in the erasure of a non-volatile seed table from the universal serial bus dongle and index values from the non-volatile index table of the personal computer utility.

15. The system as in claim 12, wherein the instructions of the personal computer utility and the universal serial bus dongle, when executed by the respective controllers, cause the personal computer utility and the universal serial bus dongle to: erase un-erased instructions from the personal computer utility or the universal serial bus dongle when a communication is made via an erased personal computer utility or the universal serial bus dongle.

16. A method comprising:
providing a personal computer utility;
providing a universal serial bus dongle to generate pseudo-random strings of characters via a pseudo-random character generator to be used as passwords,
retrieving a first index value by identifying a uniform resource locator of an internet resource requesting a password from a non-volatile index table of the personal computer utility;
sending the first index value and a first request for a password from the personal computer utility to the universal serial bus dongle;
retrieving a first seed value from a non-volatile seed table using the first index value received from the personal computer utility; and
generating a first pseudo-random number password via a pseudo-random character generator using the first seed value.

17. The method as in claim 16, comprising:
generating a second pseudo-random number password in a sequence using the first pseudo-random number password as a second seed value; and
generating a third pseudo-random number password in a sequence using the second pseudo-random number password as a third seed value.

18. The method as in claim 17, comprising:
breaking the first, second, and third pseudo-random number passwords, which are 32-bit pseudo-random numbers respectively, into 6-bit values; and
generating sequences of ASCII characters selected from: numbers, punctuation, upper case letters, and lower case letters by adding to an offset value to the 6-bit values.

19. The method as in claim 16, comprising:
sending the first pseudo-random number password to the personal computer utility for transmission to the uniform resource locator of the web resource requesting a password, if a switch on the universal serial bus dongle is activated.

20. The method as in claim 16, comprising:
storing a uniform resource locator of an internet resource requesting a password in a non-volatile index table of the personal computer utility.

21. The method as in claim 16, comprising:
sending a second index value and a second request for a password from the personal computer utility to the universal serial bus dongle.

22. The method as in claim 16, comprising:
storing the first seed value in a non-volatile seed table of the universal serial bus dongle using the first index value received from the personal computer utility.

23. The method as in claim 17, comprising:
generating via the universal serial bus dongle a second pseudo-random number password via the pseudo-random character generator using the second seed value.

24. The method as in claim 16, comprising:
transmitting the first pseudo-random number password from the universal serial bus dongle to the personal computer utility; and
transmitting the first pseudo-random number password from the personal computer utility to the uniform resource locator of the internet resource requesting a password.

25. The method as in claim 16, comprising:
connecting a single utility between the universal serial bus interface and a personal computer browser;
incorporating the instructions of the personal computer utility in a server hosting an internet resource requesting a password.

26. The method as in claim 16, comprising:
connecting a single utility between the universal serial bus interface and a personal computer browser; and
incorporating the instructions of the personal computer utility in operating instructions of the personal computer browser.

27. The method as in claim 16, comprising:
providing a pseudo-random number generator in the personal computer utility identical to the pseudo-random number generator of the universal serial bus dongle;
synchronizing the pseudo-random number generators;
starting both pseudo-random number generators with an identical initial seed value; and
causing the personal computer utility and the universal serial bus dongle to: encrypt and decrypt communications between the universal serial bus dongle and the personal computer utility using a single key cypher based on a rolling key generated by the synchronized pseudo-random number generators in the personal computer utility and the universal serial bus dongle.

28. The method as in claim 27, comprising:
concatenating a serial number of the universal serial bus dongle and a value supplied by a user to create the identical initial seed value for the synchronized pseudo-random number generators.

29. The method as in claim 27, comprising:
incrementing an error count when a communication fails to decrypt; and
erasing non-volatile seed table from the universal serial bus dongle and index values from the non-volatile index table of the personal computer utility when there is an error count of greater than a predetermined value.

30. The method as in claim 27, comprising:
erasing un-erased instructions from the personal computer utility or the universal serial bus dongle when a communication is made via an erased personal computer utility or the universal serial bus dongle.
